(19) United States
(12) Patent Application Publication
(10) Pub. No.: US 2015/0018016 A1
(43) Pub. Date: Jan. 15, 2015

(54) METHOD AND APPARATUS FOR DETERMINING USER LOCATION, AND COMMUNICATIONS SYSTEM

(71) Applicant: Huawei Technologies Co., Ltd., Shenzhen (CN)

(72) Inventors: Zhimin Zhang, Xi'an (CN); Baocheng Liu, Xi'an (CN)

(21) Appl. No.: 14/474,873

(22) Filed: Sep. 2, 2014

Related U.S. Application Data
(63) Continuation of application No. PCT/CN2012/081880, filed on Sep. 25, 2012.

(30) Foreign Application Priority Data
Mar. 1, 2012 (CN) 201210051703.8

(51) Int. Cl. H04W 4/02; H04W 64/00; H04W 4/14

(52) U.S. Cl. CPC H04W 4/023; H04W 4/14; H04W 64/00
USPC 455/456.3

(57) ABSTRACT

A method and an apparatus for determining a user location, and a communications system are provided, where the method includes: acquiring first location information of a first user equipment and second location information of a second user equipment; determining whether the first user equipment is near the second user equipment according to the first location information and the second location information; and notifying the first user equipment or the second user equipment or both of a message that the first user equipment is near the second user equipment when it is determined that the first user equipment is near the second user equipment. In the foregoing technical solutions, that whether one user equipment is near another user equipment can be determined according to acquired location information of the user equipment's, thereby improving user experience.

### CROSS-REFERENCE TO RELATED APPLICATIONS

This application is a continuation of International Application No. PCT/CN2012/081880, filed on Sep. 25, 2012, which claims priority to Chinese Patent Application No. 201210051703.8, filed on Mar. 1, 2012, both of which are hereby incorporated by reference in their entireties.

### TECHNICAL FIELD

Embodiments of the present invention relate to the field of communications technologies, and in particular, to a method and an apparatus for determining a user location, and a communications system.

### BACKGROUND

In the prior art, a user is required to report a physical location of the user to a server, so as to provide services related to a user location. The physical location may be provided by a location tracker (such as, a GPS) installed in an information device of the user.

However, generally, a GPS is not installed in an information device of a low-end user; therefore, the low-end user cannot enjoy services related to the user location.

In addition, when services related to the user location are provided on a network side, the information device of the user is required to report location information of the user. Therefore, the location information of the user cannot be actively provided to another user who has relations with the user in time.

### SUMMARY

Embodiments of the present invention provide a method and an apparatus for determining a user location, and a communications system, which can actively notify a first user of location information of another user who has relations with the first user.

According to one aspect, a method for determining a user location is provided and includes: acquiring first location information of a first user equipment and second location information of a second user equipment; determining whether the first user equipment is near the second user equipment according to the first location information and the second location information; and notifying the first user equipment or the second user equipment or both of a message that the first user equipment is near the second user equipment when it is determined that the first user equipment is near the second user equipment.

According to another aspect, a method for determining a user location is provided and includes: acquiring first location information of a first user equipment and second location information of a second user equipment from a signaling message or a switching device; and determining whether the first user equipment is near the second user equipment according to the first location information, the second location information, and a location determining policy related to the first location information and the second location information.

According to another aspect, an apparatus for determining a user location is provided and includes: an acquiring module, configured to acquire first location information of a first user equipment and second location information of a second user equipment; a processing module, configured to determine whether the first user equipment is near the second user equipment according to the first location information and the second location information; and a notifying module, configured to notify the first user equipment or the second user equipment, or both of a message that the first user equipment is near the second user equipment when it is determined that the first user equipment is near the second user equipment.

According to another aspect, an apparatus for determining a user location is provided and includes: an acquiring module, configured to acquire first location information of a first user equipment and second location information of a second user equipment from a signaling message or a switching device; and a processing module, configured to determine whether the first user equipment is near the second user equipment according to the first location information, the second location information, and a location determining policy related to the first location information and the second location information.

According to another aspect, a communications system is provided and includes: a first user equipment and a second user equipment; and a server, configured to acquire first location information of the first user equipment and second location information of the second user equipment, determine whether the first user equipment is near the second user equipment according to the first location information and the second location information, and notify the first user equipment or the second user equipment or both of a message that the first user equipment is near the second user equipment when it is determined that the first user equipment is near the second user equipment.

In the foregoing technical solutions, that whether one user equipment is near another user equipment can be determined according to acquired location information of the user equipments, so as to actively notify at least one of the two user equipments of a message that the one user equipment is near the another user equipment, thereby improving user experience.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic architectural diagram of a communications system according to an embodiment of the present invention;

FIG. 2 is a schematic flowchart of a method for determining a user location according to an embodiment of the present invention;

FIG. 3 is a schematic flowchart of a method for determining a user location according to another embodiment of the present invention;

FIG. 4 is a schematic flowchart of a method for determining a user location according to another embodiment of the present invention;

FIG. 5 is a schematic flowchart of a method for determining a user location according to an embodiment of the present invention;

FIG. 6 is a schematic flowchart of a method for determining a user location according to another embodiment of the present invention;

FIG. 7 is a schematic structural diagram of an apparatus for determining a user location according to another embodiment of the present invention; and

FIG. 8 is a schematic structural diagram of an apparatus for determining a user location according to another embodiment of the present invention.

### DETAILED DESCRIPTION

The following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

The technical solutions of the present invention may be applied to various communications systems, such as, a GSM, a Code Division Multiple Access (Code Division Multiple Access, CDMA) system, a Wideband Code Division Multiple Access (WCDMA, Wideband Code Division Multiple Access), a general packet radio service (GPRS, General Packet Radio Service) system, a Long Term Evolution (LTE, Long Term Evolution) system.

A user equipment (UE, User Equipment) may also be referred to as a mobile terminal (Mobile Terminal), a mobile user equipment, and the like. The user equipment may communicate with one or more core networks by using a radio access network (RAN, Radio Access Network). The user equipment may be a mobile terminal, such as, a mobile phone (or referred to as a “cellular” phone), or a computer with a mobile terminal; for example, the user equipment may be a portable, pocket-sized, handheld, computer built-in, or vehicle-mounted mobile apparatus, and exchange voice or data or both with a radio access network.

A base station may be a base transceiver station (BTS, Base Transceiver Station) in GSM or CDMA, may also be a NodeB (NodeB) in WCDMA, and may further be an evolutional NodeB (eNB, or e-NodeB, evolutional Node B) in the LTE, which is not limited in the present invention. However, for ease of description, the following embodiments are described by using a Node B as an example.

On a mobile network, when a location area of a UE changes, a location update process is triggered. For example, when a location of the UE is updated, the UE may report a location area code (LAC, Location Area Code) of the UE to a mobile switch center (MSC, Mobile Switch Center) by using a base station. The location area code is used to identify an actual geographical location. The LAC, mobile country code (MCC, Mobile Country Code), and mobile network code (MNC, Mobile Network Code) form a location area identity (LAI, Location Area Identity). The location area identity (LAI, Location Area Identity) and a cell identity (CI, Cell Identity) form a cell global identifier (CGI, Cell Global Identifier). The LAC is sent in a system message on each cell broadcast channel. When the UE is powered on or is inserted with a SIM card, or discovers that LAC of a current cell broadcast is different from LAC stored on the UE, a current location area of the UE is reported to a network side by using IMSI attach (International Mobile Subscriber Identification Number Attach) or a location update process.

When a user is near a friend in a geographical location, if the user can be notified that the friend is nearby, a social behavior of a user is facilitated to a large extent, thereby improving user experience.

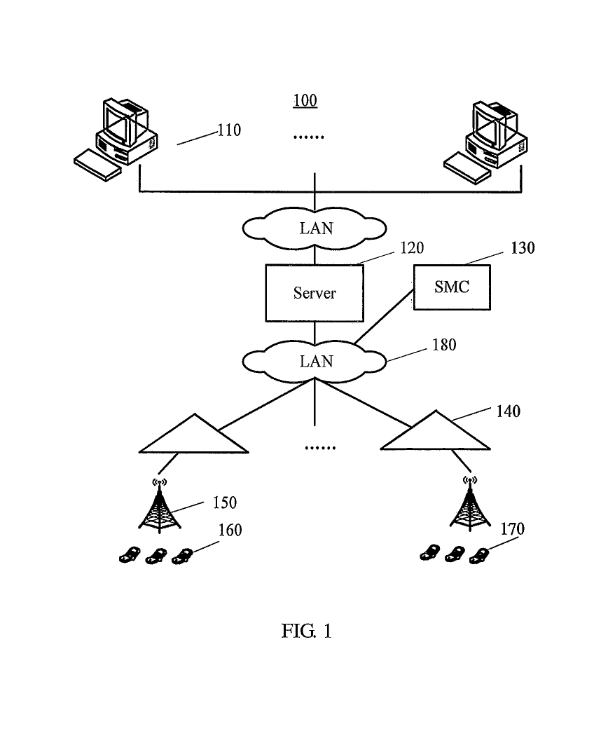

FIG. 1 is a schematic architectural diagram of a communications system 100 according to an embodiment of the present invention. The communications system 100 may include: a network management client/business operation support system (BOSS, Business Operation Support System) 110, a server 120, a short message center (Short Message Center, SMC) 130, a mobile switch center (MSC) 140, a base station 150, a UE 160, and a UE 170, where the server 120 may be connected to the network management client/BOSS 110, the SMC 130, and the MSC 140 by means of a local area network (Local Area Network, LAN) 180. The local area network 180 may be a maintenance network.

The network management client/BOSS 110 is configured to provide the server 120 with service registration information of the UE 160, where the service registration information includes an identity of the UE 160 and an identity of the UE 170 and indication information for registering a service. The short message center 130 is configured to notify the UE 160 or the UE 170 or both of a message that the UE 160 is near the UE 170 in a manner of an SMS message or a multimedia message after a request of the server 120 is received.

The server 120 may be an apparatus configured to determine a user location according to the embodiment of the present invention. The server 120 may acquire location information of the UE 160 and location information of the UE 170, determine whether the UE 160 is near the UE 170 according to the location information of the UE 160 and the location information of the UE 170, and notify the UE 160 or the UE 170 or both of the message that the UE 160 is near the UE 170 when it is determined that the UE 160 is near the UE 170. For example, the server 120 may send an SMS message notification to the user by means of the SMC when it is determined that the friend of the user is nearby.

According to the embodiment of the present invention, the server 120 may be a signaling collection integration server, and has functions of signaling collection, service bill integration, and determining of the user location. The communications system 100 may further include an external probe disposed on an interface between the switching device 140 and the base station 150, where the external probe is configured to collect signaling messages of the UE 160 and the UE 170.

Optionally, as another embodiment, the server 120 may further be a local server that is configured to acquire location information of the UE 160 and location information of the UE 170 from a service bill provided by the switching device 140. Correspondingly, the switching device 140 may be a soft switching device, such as, an MSC, and is configured to provide the server 120 with a service bill, where the service bill includes the location information of the UE 160 and the location information of the UE 170.

According to the embodiment of the present invention, that whether one UE is near another UE can be determined according to acquired location information of UEs, so as to actively notify at least one of the two UEs of a message that the one UE is near the another UE, thereby improving user experience.

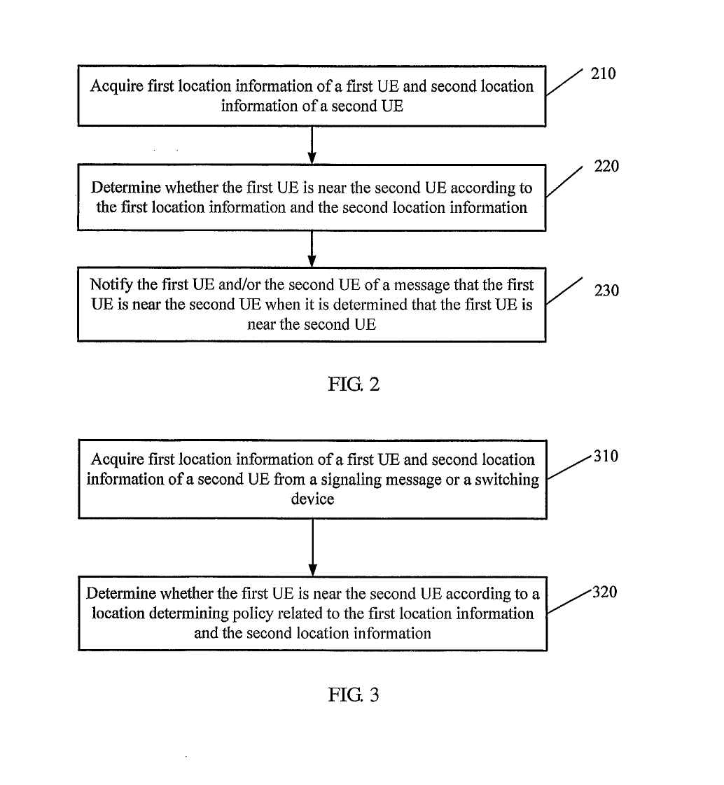

FIG. 2 is a schematic flowchart of a method for determining a user location according to an embodiment of the present invention. The method shown in FIG. 2 may be executed by the server 120 shown in FIG. 1.

210: acquire first location information of a first UE and second location information of a second UE.

For example, the foregoing location information may include at least one of MSC identification information, location area identification information, and cell identification information, which is not limited in the embodiment of the present invention. For example, the foregoing location information may be other information that is capable of identifying a UE location. The MSC identification information may be an MSC identity, the location area identification information may be a LAI or LAC, and the cell identification information may be a CI or a CGI. For example, an MSC coverage area identified by the MSC identity includes an area identified by the LAC, and the area identified by the LAC includes a cell coverage area identified by the CI. Therefore, the MSC identity may be independently used to indicate location information of the UE, the MSC identity in addition to the LAC may be used to indicate location information of the UE, or the MSC identity in addition to the LAC and the CI may also be used to indicate location information of the UE, so as to provide location information with different precision for a user. For example, there may be at least one second UE.

For example, the foregoing location information may be acquired by using signaling messages of each interface (such as, an interface of a core network) in a communications system, which is not limited in the embodiment of the present invention. For example, the foregoing location information may also be acquired from other devices (such as, an MSC) that store the foregoing location information.

220: determine whether the first UE is near the second UE according to the first location information and the second location information.

For example, if the acquired location information of the first UE is the same as or consistent with the location information of the second UE, it indicates that the first UE is near the second UE.

230: notify the first UE or the second UE or both of a message that the first UE is near the second UE when it is determined that the first UE is near the second UE.

For example, when it is determined that the first UE is near the second UE, a user of the first UE or the second UE or both may be notified in a manner of an SMS message or a multimedia message, which is not limited in the embodiment of the present invention. For example, the user may also be notified in a manner of a voice or other communications manners.

According to the embodiment of the present invention, that whether one UE is near another UE can be determined according to acquired location information of UEs, so as to actively notify at least one of the two UEs of a message that the one UE is near the another UE, thereby improving user experience.

According to the embodiment of the present invention, the method shown in FIG. 2 further includes: acquiring service registration information of the first UE, where the service registration information includes first identification information of the first UE, second identification information of the second UE, and indication information for registering a service. Correspondingly, the step 210 may includes: acquire first location information that corresponds to the first identification information and second location information that corresponds to the second identification information according to the first identification information and the second identification information. Correspondingly, the step 220 may includes: it is determined whether the first UE is near the second UE according to whether the first location information and the second location information are the same or whether the first location information and the second location information are in a same set.

For example, when the first UE and the second UE are mobile terminals, an identity of a UE may be a mobile terminal number of a user or a mobile subscriber international ISDN number (MSISDN, Mobile Subscriber International ISDN number).

For example, the foregoing service registration information may be acquired from a network management device/BOSS, and that whether location information that corresponds to an identity of a UE of a user A is the same as location information that corresponds to an identity of a UE of a user B is determined according to identification information of the UEs of the user A included in the foregoing service registration information and the user B, a friend of the user A. If the location information that corresponds to the identity of the UE of the user A is the same as the location information that corresponds to the identity of the UE of the user B, it indicates that the UE of the user B is near the UE of the user A. For example, according to the embodiment of the present invention, location information of a UE of a user may be acquired (for example, searching) from a service bill or a list that records the location information of the UE according to identification information of the UE of the user, and location information of a UE of a friend may be acquired from a service bill or a list that records the location information of the UE of the friend according to identification information of the UE of the friend of the user. According to the embodiment of the present invention, that a value-added service function of actively notifying that a friend is nearby in real time may be implemented. For an operator, the function is deployed simply, and can be separately charged; and for a user, the function is simple and convenient, and can be used immediately after registration.

Optionally, as another embodiment, the method shown in FIG. 2 further includes: sending a service enabling request to a second UE through a short message center, so as to request the second UE to allow a first UE to register a service. In the step 220, when the second UE allows the first UE to register the service, that whether the first UE is near the second UE may be determined according to whether first location information and second location information are the same or in a same set.

For example, a service that aims at a friend can be enabled only when the friend of a user agrees, so as to protect privacy of a friend who is reluctant to participate in this service.

Optionally, as another embodiment, the method shown in FIG. 2 further includes: acquiring service registration information of a first UE, where the service registration information includes first identification information of the first UE, second identification information of a second UE, and indication information that a service has been enabled. In the step 210, first location information that corresponds to the first identification information and second location information that corresponds to the second identification information may be acquired according to the first identification information and the second identification information. In the step 220, that whether the first UE is near the second UE may be determined according to whether the first location information and the second location information are the same or in a same set.

For example, before the service registration information of the first UE is acquired, if a user has registered the service in another manner, and a friend has allowed to enable the service, and in this case, the foregoing service registration information includes indication information that the service has been enabled, that is, it is indicated that the friend of the user allows to enable the service. For example, according to the embodiment of the present invention, location information of a UE of a user may be acquired (for example, searching) from a service bill or a list that records the location information of the UE according to identification information of the UE of the user, and location information of a UE of a friend may be acquired from a service bill or a list that records the location information of the UE of the friend according to identification information of the UE of the friend of the user.

Optionally, as another embodiment, the method shown in FIG. 2 further includes: acquiring service deregistration information of a first UE, where the service deregistration information includes first identification information, second identification information, and indication information for deregistering a service; and deleting the second identification information and second location information, or deleting the first identification information, the second identification information, first location information, and the second location information according to the indication information for deregistering a service.

According to the embodiment of the present invention, the method shown in FIG. 2 further includes: collecting a signaling message transmitted on an interface of a core network by using a probe, where the signaling message includes one or more first signaling messages of the first UE and one or more second signaling messages of a second UE, the one or more first signaling messages includes the first identification information of the first user equipment and the first location information that corresponds to the first identification information, and the one or more second signaling messages includes the second identification information of the second user equipment and the second location information that corresponds to the second identification information. In the step 210, the first location information may be acquired from the one or more first signaling messages according to the first identification information, and the second location information may be acquired from the one or more second signaling messages according to the second identification information.

For example, the at least one signaling message may refer to any signaling message from which current MSC identification information, location area identification information or cell identification information or both of a user may be extracted, for example, a signaling message that is transmitted on each interface (such as, an A interface, a C interface, a D interface, and an E interface of an MSC) of a communications system and is in each signaling process, where signaling processes related to location information include, such as, a location update progress.

For example, a signaling message transmitted on an interface between an MSC part of the core network and a base station of a wireless network may be collected by using an external probe.

Optionally, as another embodiment, the method shown in FIG. 2 further includes: collecting a signaling message transmitted on an interface of a core network by using a probe, where the signaling message includes one or more first signaling messages of a first user equipment and one or more second signaling messages of a second user equipment; integrating the collected one or more first signaling messages into a first service bill, and integrating the collected one or more second signaling messages into a second service bill, where the first service bill includes first identification information of the first UE and first location information that corresponds to the first identification information, and the second service bill includes second identification information of the second UE and second location information that corresponds to the second identification information. In the step 210, the first location information that corresponds to the first identification information may be acquired from the first service bill according to the first identification information, and the second location information that corresponds to the second identification information may be acquired from the second service bill according to the second identification information.

For example, a signaling message flow transmitted on an interface between the MSC and the base station may be integrated into a service bill. Because the service bill may include a calling service bill, a bill of a location update type, and the like, location information that corresponds to an identity (or a number) of a UE of a user may be acquired by parsing (for example, inquiring) the service bill.

Optionally, the first service bill and the second service bill may also be recorded as a list, and the first location information and the second information may be acquired by inquiring the service bill according to the first identification information and the second identification information.

For example, location information and identification information in service bills of each UE may be extracted and represented in a form of a list or data, and location information of the UEs may be acquired by inquiring the list.

Optionally, as another embodiment, the method shown in FIG. 2 further includes: establishing a network connection to a switching device; and acquiring a first service bill of a first UE and a second service bill of a second UE from the switching device by using the network connection, where the first service bill includes first identification information of the first UE and first location information that corresponds to the first identification information, and the second service bill includes second identification information of the second UE and second location information that corresponds to the second identification information. In the step 210, the first location information that corresponds to the first identification information may be acquired from the first service bill according to the first identification information, and the second location information that corresponds to the second identification information may be acquired from the second service bill according to the second identification information.

For example, the switching device may generate a corresponding service bill when each UE performs one service, where the service bill (such as, a bill of a location update type) may include time information of an occurrence of the service, user number information, and location information of a user (such as, an MSC identity, an location area identity, and a cell identity). According to the embodiment of the present invention, the location information of a user may be acquired (searched) from a service bill of the user according to identification information of a UE of the user, and location information of a friend of the user may be acquired from a service bill of the friend of the user according to identification information of a UE of the friend of the user.

According to the embodiment of the present invention, in the step 220, that whether the first UE is near the second UE may be determined according to the first location information, the second location information, and a location determining policy related to the first location information and the second location information, where the first location information includes at least one of mobile switch center identification information, location area identification information, and cell identification information, and the second location information includes at least one of mobile switch center identification information, location area identification information, and cell identification information.

For example, the foregoing related location determining policy may be that whether the first location information of the first user equipment and the second location information of the second user equipment are the same or in a same set. If the first location information of the first user equipment and the second location information of the second user equipment are the same, it indicates that the first UE is near the second UE. The foregoing location determining policy may be a preset policy, and may also be dynamically set by an operator by using a network management client/BOSS according to a requirement.

According to the embodiment of the present invention, in the step 220, if the mobile switch center identification information included in the first location information is the same as the mobile switch center identification information included in the second location information, it is determined that the first UE is near the second UE.

Optionally, as another embodiment, in the step 220, if the cell identification information included in the first location information is the same as the cell identification information included in the second location information, it is determined that the first UE is near the second UE. For example, the forgoing cell identification information may refer to a CI or a CGI.

Optionally, in the step 220, if the location area identification information included in the first location information is the same as the location area identification information included in the second location information, it is determined that the first UE is near the second UE.

Optionally, as another embodiment, in the step 220, if the location area identification information included in the first location information is the same as the location area identification information included in the second location information, it is determined that the first UE is near the second UE. For example, the location area identification information may be a LAI or a LAC.

Optionally, as another embodiment, in the step 220, if a location area code included in the first location information and a location area code included in the second location information are in a same set, it is determined that the first UE is near the second UE.

For example, several location area codes for identifying areas which are near with each other may be set in a same set, and when it is determined that a location area code of a user and a location area code of a friend of the user are in a same set, it may be determined that the friend is near the user.

According to the embodiment of the present invention, in the step 230, a short message center notifies the first UE or the second UE or both of a message that the first UE is near the second UE in a manner of an SMS message or a multimedia message, so as to help a user to send an SMS message or make a call to a friend after receiving SMS message notification, which improves real-time performance; and it is more congruous to a usage custom of a user by notifying the user that the friend is near the user in the manner of an SMS message, thereby improving user experience. In addition, it is accurate to notify information by using an SMS message, and the user may enjoy a service that the friend is near the user without using a terminal installed with a location tracker.

Optionally, as another embodiment, a switching device may be requested to notify the first user equipment or the second user equipment or both of a message that the first user equipment is near the second user equipment in a manner of a voice. For example, a switching device may be requested to notify a user in a manner of a voice by simulating a user terminal.

Optionally, as another embodiment, an instant message server may be requested to notify the first user equipment or the second user equipment or both of a message that the first user equipment is near the second user equipment in a manner of an instant chatting message.

Optionally, as another embodiment, the method shown in FIG. 2 further includes: receiving and storing first location name information that corresponds to first location information or second location name information that corresponds to second location information. In the step 230, a second UE may be notified of the first location name information. Optionally, in the step 230, a first UE may be notified of the second location name information. Optionally, in the step 230, a first UE may be notified of the second location name information and a second UE may be notified of the first location name information.

For example, a location name that corresponds to an MSC identity may refer to an actual physical location that corresponds to the foregoing location information, for example, a name of a province or a city; a location name that corresponds to a cell identity may be a name of a sub-district.

Optionally, as another embodiment, the method shown in FIG. 2 further includes: determining first longitude and latitude information of a first UE according to first location information, or determining second longitude and latitude information of a second UE according to second location information. In the step 230, the second UE may be notified of the first longitude and latitude information. Optionally, in the step 230, the first UE may be notified of the second longitude and latitude information. Optionally, in the step 230, the first UE may be notified of the second longitude and latitude information and the second UE may be notified of the first longitude and latitude information.

For example, the foregoing location information and the foregoing location name information may be converted into longitude information and latitude information, which are sent to a user in the foregoing SMS message. For example, if a user has a device such as a location tracker, an area in which the user is located may be quickly found according to the foregoing longitude information and latitude information.

Optionally, as another embodiment, the method shown in FIG. 2 further includes: after a first UE or a second UE or both is notified of a message that the first UE is near the second UE, and in a case that the first UE or the second UE moves within a preset scope, stopping notifying the first UE or the second UE or both again of the message that the first UE is near the second UE.

For example, once the first UE is near the second UE (such as, an MSC identity that corresponds to the first UE is the same as an MSC identity that corresponds to the second UE), an SMS message is sent to notify the first UE or the second UE. then when the first UE and the second UE are in a coverage area of an MSC that corresponds to the MSC identity, the SMS message is not sent further to notify the first UE or the second UE, unless the user re-enters the coverage area of the MSC again after moving out of the coverage area of the MSC.

FIG. 3 is a schematic flowchart of a method for determining a user location according to another embodiment of the present invention. The method shown in FIG. 3 may be executed by the server 120 shown in FIG. 1.

310: Acquire first location information of a first UE and second location information of a second UE from a signaling message or a switching device.

For example, location information of the UE is acquired from a signaling message of the UE that is transmitted on an interface of a core network, or location information of the UE is acquired from a service bill generated by the switching device for each service of the UE.

320: Determine whether the first UE is near the second UE according to the first location information, the second location information, and a location determining policy related to the first location information and the second location information.

For example, the foregoing location information may include at least one of MSC identification information, location area identification information, and cell identification information, which is not limited in the embodiment of the present invention. For example, the foregoing location information may be other information that is capable of identifying a UE location. The MSC identification information may be an MSC identity, the location area identification information may be a LAI or LAC, and the cell identification information may be a CI or a CGI.

According to the embodiment of the present invention, that whether a friend of a user is nearby may be determined according to location information that is of the UE and is acquired from the signaling message or the switching device, so as to provide location information for a service related to the location information, thereby improving user experience.

According to the embodiment of the present invention, the first location information includes at least one of mobile switch center identification information, location area identification information, and cell identification information, and the second location information includes at least one of mobile switch center identification information, location area identification information, and cell identification information. In the step 320, if the mobile switch center identification information included in the first location information is the same as the mobile switch center identification information included in the second location information, it is determined that the first UE is near the second UE; or if the cell identification information included in the first location information is the same as the cell identification information included in the second location information, it is determined that the first UE is near the second UE; or if the location area identification information included in the first location information is the same as the location area identification information included in the second location information, it is determined that the first UE is near the second UE; or if a location area code included in the first location information and a location area code included in the second location information are in a same set, it is determined that the first UE is near the second UE.

The embodiment of the present invention is further described in the following in detail with reference to a specific example.

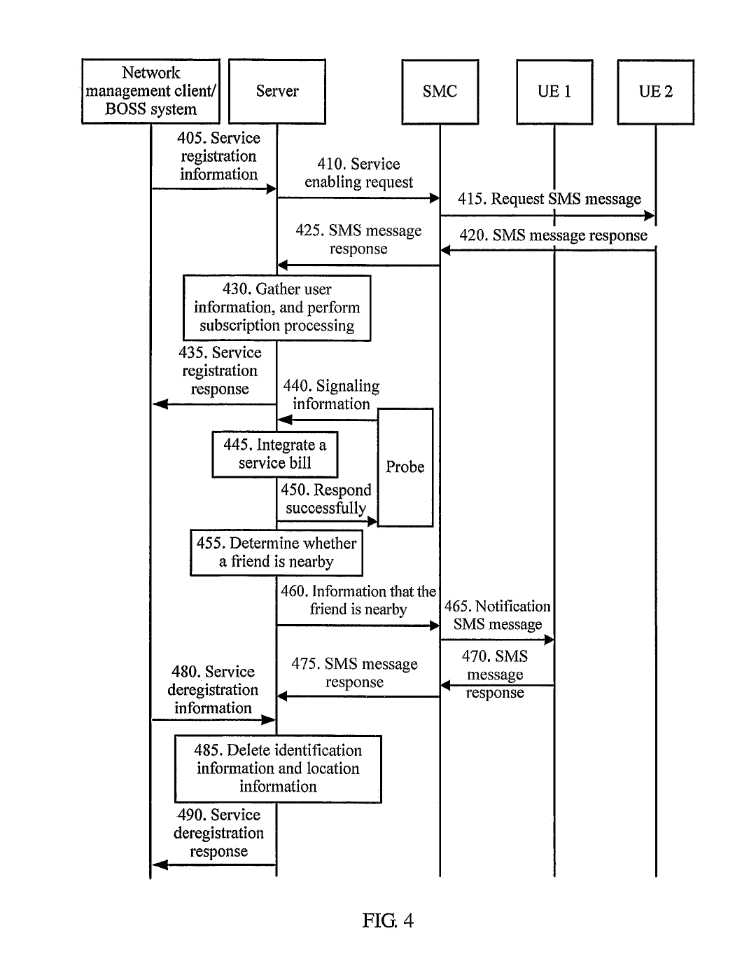

FIG. 4 is a schematic flowchart of a method for determining a user location according to another embodiment of the present invention.

405: A network management client/business operation support system (BOSS, Business operation support system) sends service registration information to a server.

For example, one server may be set in each area (such as, a province or a city) of an operator. The server is connected to a maintenance network of an area in which the server is located and has a function of signaling collection and service bill integration, and can implement a notification service that a friend is nearby. Therefore, the server may also be called a signaling collection integration server.

For example, after a user A transacts the service by using a mobile terminal or an internet or going to a counter of an operator, the network management client/BOSS may generate service registration information of the user A, and send the service registration information to the server in each area.

For example, a format of the foregoing service registration information may be “command code: enabled; user number: A; number of a friend: B, C, D”, where the command code is used to indicate that the user A is required to enable the notification service that a friend is nearby. For example, the service may notify the user A when a user B, C, or D is near the user A by using an SMS message, so that the user A knows that the user B, C, or D is near the user A. Optionally, the users B, C, and D may also be notified simultaneously, so that the users B, C, and D know that the user A is near the users B, C, and D. Optionally, the service registration information may also carry a user name, so that the user name may be displayed in an SMS message for notification when a friend of the user is notified.

410: After receiving the foregoing service registration information, the server sends a service enabling request message to an SMC, where the service enabling request message is used to determine whether a friend of the user allows the user to enable the service.

For example, the server requests the SMC to send an SMS message for requesting service enabling to UEs (such as, a UE 2) of the users B, C and D by using the service enabling request message, where the SMS message for requesting service enabling is used to determine whether the users B, C and D allow the user A to enable the service. For example, the service enabling request message may carry information about whether the user A is allowed to enable a service that a friend is nearby. Correspondingly, the service enabling request message may be used to identify the user A by using an identity of a UE (such as, a user number) or a name of the user A.

415: The SMC sends an SMS message for requesting service enabling to the UE 2, where the SMS message for requesting service enabling is used to determine whether a user of the UE 2 allows a user of the UE 1 to enable the service.

For example, after receiving the service enabling request message, the SMC sends the SMS message for requesting service enabling to the UE (for example, a UE 2) of the user B, C, or D who is a friend of the user A. The SMS message for requesting service enabling may carry, for example, information about whether the user A is allowed to enable the service that a friend is nearby.

420: The UE 2 sends an SMS message response to the SMC.

For example, the user B, C, or D may notify the SMC of whether the user B, C, or D allows the user A to enable the service according to a reply “Yes” or “No” of the UE of the user B, C, or D in enabling a response SMS message.

425: After receiving an SMS response message sent by the UE 2, the SMC forwards the SMS response message to the server.

Optionally, the SMC may screen SMS message response messages sent by UEs of many friends, and send a result of screening by using one response message. For example, if only the users B and C allow the user A to enable the service, identities of the UEs of the users B and C may be carried in the response message, where the identities of the UEs of the users B and C are used to indicate that the users B and C allow the user A to enable the service.

430: After receiving the foregoing SMS response message sent by the user from the SMC, the server gathers user information included in the SMS message response messages, and performs corresponding service subscription processing.

For example, that whether a corresponding user allows the user A to enable the service may be determined according to content in the SMS message response message, and only a user that allows the user A to enable the service is allowed to perform service subscription processing. For example, a user that allows the user A to know location information of the user A is recorded. That is, relevant information of the user that allows the user A to enable the service may be set on the server. For example, if only the users B and C allow the user A to enable the service, service subscription information is set on the server, where the service subscription information may include an identity of a UE of the user A, and an identity of the UE of the user B, and an identity of the UE of the user C that correspond to the identity of the UE of the user A.

Optionally, the service subscription information of the user may be recorded in a form of a list. For example, one field of a line in the list records the identity of the UE of the user A, and other lines record identities of the UEs of the users B, C, and D. The service subscription information of the user is not limited to be recorded in a form of a list in the embodiment of the present invention, and may also be recorded in a form of an array, and the like.

435: The server replies a service registration response to the network management client/BOSS, so that the network management client/BOSS performs relevant processing such as charging.

For example, the service registration response may include: whether the user A successfully enables the service, and which friends of the user A allow the user A to enable the service. It should be understood that the step 435 is optional.

440: The server collects signaling messages of each interface on a communications network. For example, when a UE roams to an area in which the server is located, in a location update progress of a UE, a signaling message is exchanged between a base station controller and the MSC. In this case, the server may detect an interface between the MSC and the base station controller by using an external probe to test or collect the signaling message of the UE. The external probe is connected to these interfaces by means of a signaling message collection technology such as a common crossover technology and a concatenation technology.

445: The server integrates collected signaling messages into a service bill (bill), and the server parses the service bill to acquire location information of a UE and identification information of a UE.

For example, the server may integrate a signaling message flow collected from the interfaces on the communications system into a service bill, where the service bill may include a bill of a location update type, a bill of a calling type, or the like. Optionally, the server may further monitor integrated bills of a location update type in service bills of each UE at the same time, and record identities of the UEs in the bills of a location update type of each UE, for example, user number information (such as, an MSISDN), and location information of a UE that corresponds to the identity (such as, an MSC identity, a location area code, and a cell identity). For example, user number information and corresponding location information may be stored in a form of a list or an array.

450: After integrating the service bill, the server replies to a probe with a notification message that integration of service bills is successful. It should be understood that the step 450 is optional.

455: The server determines whether the friend is nearby according to the user number information and the location information of the UE in the foregoing service bill and subscription information of the user.

Optionally, that whether the friend is nearby may be determined according to the user number information and the location information of the UE that are recorded in the list and the subscription information of the user.

For example, after the server acquires the location information of the UE and a user identity by inquiring the service bill or the list that records the location information, it may be determined that whether to send an SMS message to the user. For example, the server may know friend information that is registered by the user A is the users B, C, and D according to the subscription information of the user, parses the service bill, and learns that a current location of the user A is {MSC_A, LAI_A, CGI_A}, and a current location of the user B is {MSC_B, LAI_B, CGI_B}. If the MSC_B is the same as the MSC_A, that is, the MSC_B and the MSC_A belong to a same area, it is determined that a friend B of the user A is near the user A. Optionally, it may also be determined that the friend B of the user A is near the user A when the MSC_B is the same as the MSC_A and a LAI_B is the same as a LAI_A or the CGI_B or both is the same as the CGI_A.

For example, the server may periodically determine whether two pieces of location information are consistent by comparing location information of the user A with location information of the user B. If the two pieces of location information are consistent, it is determined that the user B is near the user A. Optionally, the server may determine whether two pieces of location information are consistent by comparing the location information of the user A with the location information of the user B only when it is monitored that a location of the user A or a friend of the user A is updated. If the two pieces of location information are consistent, it is determined that the user B is near the user A.

Optionally, areas of each MSC number may be set on the server, and LAI information and CGI information in the MSC may be imported to the server by using a back administration module (Back Administration module, BAM), so that the server may notify the user of specific location name information.

460: When determining that the friend of the user is nearby, the server sends an SMS message sending request to the SMC, where the SMS message sending request is used to request the SMC to send an SMS message to the user, so as to notify the user that the friend is near the user.

For example, if the server determines that the friend of the user A is near the user A, the server sends the foregoing SMS message sending request to the SMC, where the SMS message sending request is used to request the SMC to send an SMS message for notification to the user A. The foregoing SMS message sending request may include information of indicating that the user B is near the user A, and in the SMS message sending request, the user B may be identified by using the identity of the UE of the user B or a name of the user B.

In addition, the LAI_B and the CGI_B may also be converted into an actual location name and sent as content of the SMS message to the user A. Optionally, the server may also send an SMS message to the user B at the same time, and send an actual location name converted by the LAI_A and the CGI_A as content of the SMS message to the user B.

Optionally, before sending the SMS message to the user and the friend of the user by using the SMC, the server determines whether the friend of the user is in a state of not sending an SMS message according to a context of the user. If the friend is in a state of not sending an SMS message, SMS message notification is sent. After sending of the SMS message is complete, at the same time, a state of having sent an SMS message is recorded for the friend of the user in the context of the user. When the user roams out from the foregoing area in which the MSC is located, states in contexts of the user and the friend of the user are updated to states of not sending an SMS message. That is, when the user and the friend of the user move within a same area, the user or the friend of the user is not frequently notified by using an SMS message further. Optionally, that whether an SMS message has been sent to the friend may also be recorded in the context of the friend of the user.

465: After receiving a request from the server, the SMC sends an SMS message to the UE 1.

For example, the SMC sends the foregoing SMS message to the UE (such as, the UE 1) of the user A.

470: After receiving an SMS message for notification sent by the SMC, the UE 1 sends an SMS message response to the SMC.

For example, the SMS message response is used to notify the SMC that the foregoing SMS message has been received. It should be understood that the step 470 is optional.

475: After receiving the SMS message response, the SMC forwards the SMS message response to the server.

Optionally, when the user needs to deregister the foregoing service, the steps 480 to 490 may also be performed according to the embodiment of the present invention.

480: The network management client/BOSS sends service deregistration information to the server.

For example, after the user A transacts a procedure for deregistering the service by using a mobile terminal or a network or going to a counter of an operator, the network management client/BOSS may generate service deregistration information of the user A, and send the service deregistration information to the server.

For example, a format of the foregoing service deregistration information may include “command code: deregistering; user number: A; number of a friend: B, C, D”, where the “command code: deregistering; user number: A; number of a friend: B, C, D” is used to indicate that the user A needs to deregister a notification service that a friend is nearby. Optionally, the service may also be deregistered selectively for some friends, for example, if the user A only deregisters the service for the friend B, the foregoing service deregistration information may include: “command code: deregistering; user number: A; number of a friend: B”.

485: The server deletes corresponding configuration information after receiving the foregoing service deregistration information.

For example, the server may delete identification information and location information of the user A and the friend of the user A according to the service deregistration information. When the user A deregisters the service only for the friend B, only relevant information of the friend B is deleted, and the user still can use the service for the friends C and D.

490: The server replies a service deregistration response to the network management client/BOSS, so that the network management client/BOSS performs relevant processing such as charging. It should be understood that the step 490 is optional.

In the embodiment of the present invention, information interacted between the foregoing devices may use a form of a dedicated signaling message, or may be carried by using an existing message, which is not limited in the present invention.

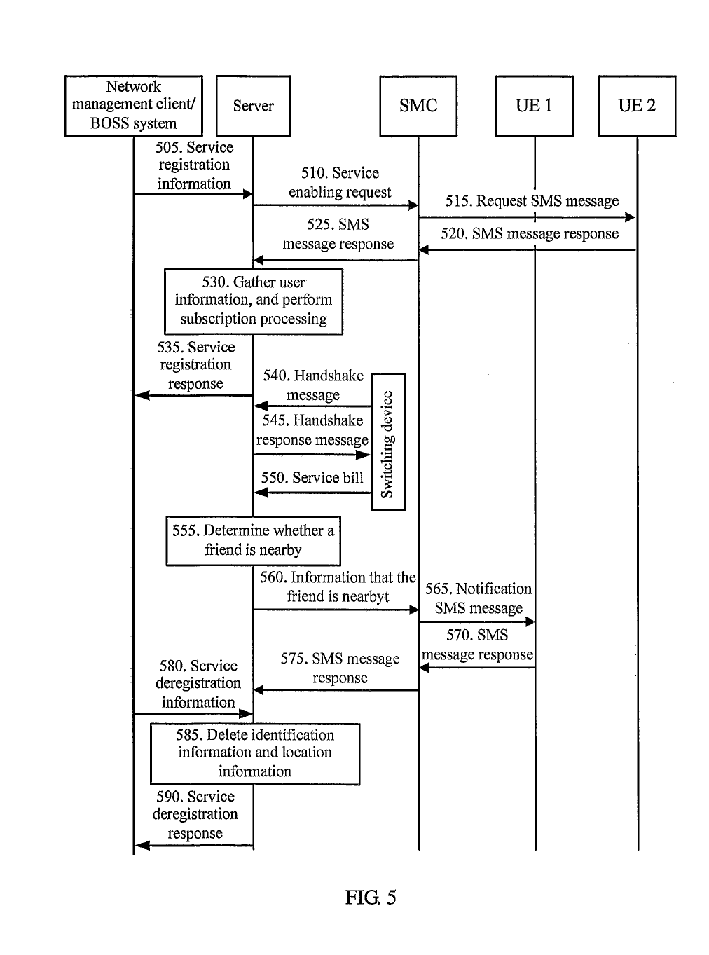

FIG. 5 is a schematic flowchart of a method for determining a user location according to one embodiment of the present invention. An embodiment in FIG. 5 is an example of the method shown in FIG. 2. The steps 505 to 535 in FIG. 5 are similar to the steps 405 to 435 in FIG. 4, and the steps 555 to 590 in FIG. 5 are similar to the steps 455 to 490 in FIG. 4. Details are not described herein again.

505: A network management client/business operation support system (BOSS, Business operation support system) sends service registration information to a server.

For example, the server may be connected to maintenance networks of each area (such as, a province or a city) of an operator, and the server is used to implement a notification service that a friend is nearby, and may also be called a local server.

510: After receiving the foregoing service registration information, the server sends a service enabling request message to an SMC, where the service enabling request message is used to determine whether a friend of the user allows the user to enable the service.

515: The SMC sends an SMS message for requesting service enabling to a UE 2, where the SMS message for requesting service enabling is used to determine whether a user of the UE 2 allows a user of a UE 1 to enable the service.

520: The UE 2 sends an SMS message response to the SMC.

525: After receiving the SMS response message sent by the UE 2, the SMC forwards the SMS response message to the server.

530: After receiving the foregoing SMS response message sent by the user from the SMC, the server gathers user information included in the SMS response message, and performs corresponding service subscription processing.

535: The server replies a service registration response to the network management client/BOSS, so that the network management client/BOSS performs relevant processing such as charging.

540: A switching device sends a handshake message to the server.

For example, the switching device may be a soft switching device that is connected to a base station and a maintenance network. The switching device sends the handshake message to the server, so as to determine whether the server is in a working state. Optionally, the switching device may periodically send a handshake message to the server.

545: The server sends a handshake response message to the switching device.

After receiving the handshake message, the server may reply the handshake response message to the switching device, so as to notify the switching device that the server is at work. It should be understood that the steps 540 and 545 are optional.

550: The switching device determines to send a service bill to the server.

For example, the switching device may generate a service bill for each service that occurs to each user. For example, for location update, a call, switching, an SMS message, a location service (Location Service, LCS), unstructured supplementary services data (Unstructured Supplementary Services Data, USSD), and the like, whether a service is successful or not, one piece of service bill may always be generated, where the service bill includes time information of an occurrence of the service, user number information (for example, MSISDN of calling and called parties) and location information of the user (such as, an MSC identity, an location area identity, and a cell identity).

For example, the switching device may use a standard TLV (tag, length, value, Tag, Length, Value) format on an application layer to assemble each piece of service bill, and uses a transport control protocol (Transport Control Protocol, TCP) or a user datagram protocol (User Datagram Protocol, UDP) to send the service bill to the server.

555: The server may receive the foregoing service bill from the switching device, and determine whether the friend is nearby according to the user number information and the location information of the UE in the foregoing service bill and subscription information of the user.

For example, the server may monitor bills of a location update type in service bills of each UE, and record identities of UEs in the bills of a location update type of each UE in a form of a list or an array, for example, user number information (such as, an MSISDN), and location information (such as, an MSC identity, a location area code, and a cell identity) that corresponds to an identity of a UE. The server may inquire, according to identities of the user and the friend of the user in the subscription information, the foregoing service bill or list to acquire location information of the UE and the friend of the user, thereby determining whether to send an SMS message to the user.

For example, the server may know friend information that is registered by the user A is the users B, C, and D according to the subscription information of the user, and learns, according to the foregoing service bill or a list recording location information, that a current location of the user A is {MSC_A, LAI_A, CGI_A}, and a current location of the user B is {MSC_B, LAI_B, CGI_B}. If the MSC_B is the same as the MSC_A, that is, the MSC_B and the MSC_A belong to a same area, it is determined that a friend B of the user A is near the user A. Optionally, it is also determined that a friend B of the user A is near the user A when the MSC_B is the same as the MSC_A and a LAI_B is the same as a LAI_A or the CGI_B or both is the same as the CGI_A.

For example, the server may periodically determine whether two pieces of location information are consistent by comparing location information of the user A with location information of the user B. If the two pieces of location information are consistent, it is determined that the user B is near the user A. Optionally, the server may determine whether two pieces of location information are consistent by comparing the location information of the user A with the location information of the user B only when it is monitored that a location of the user A or a friend of the user A is updated. If the two pieces of location information are consistent, it is determined that the user B is near the user A.

Optionally, areas of each MSC number may be set on the server, and LAI information and CGI information in the MSC may be imported to the server by using a back administration module (Back Administration module, BAM), so that the server may notify the user of specific location name information.

560: When the server determines that the friend of the user is nearby, the server sends an SMS message sending request to the SMC, where the SMS message sending request is used to request the SMC to send an SMS message to the user, so as to notify the user that the friend is near the user.

565: After receiving the request from the server, the SMC sends the SMS message to the UE 1.

For example, the SMC sends the foregoing SMS message to the UE (such as, the UE 1) of the user A.

570: After receiving an SMS message for notification sent by the SMC, the UE 1 sends an SMS message response to the SMC.

575: After receiving the SMS message response, the SMC forwards the SMS message response to the server. It should be understood that the steps 570 and 575 are optional.

Optionally, when the user needs to deregister the foregoing service, the steps 580 to 590 may also be performed according to the embodiment of the present invention.

580: The network management client/BOSS sends service deregistration information to the server.

585: The server deletes corresponding configuration information after receiving the foregoing service deregistration information.

590: The server replies a service deregistration response to the network management client/BOSS, so that the network management client/BOSS performs relevant processing such as charging. It should be understood that the step 590 is optional.

In the embodiment of the present invention, information interacted between the foregoing devices may use a dedicated signaling message, or may be carried by using an existing message, which is not limited in the present invention.

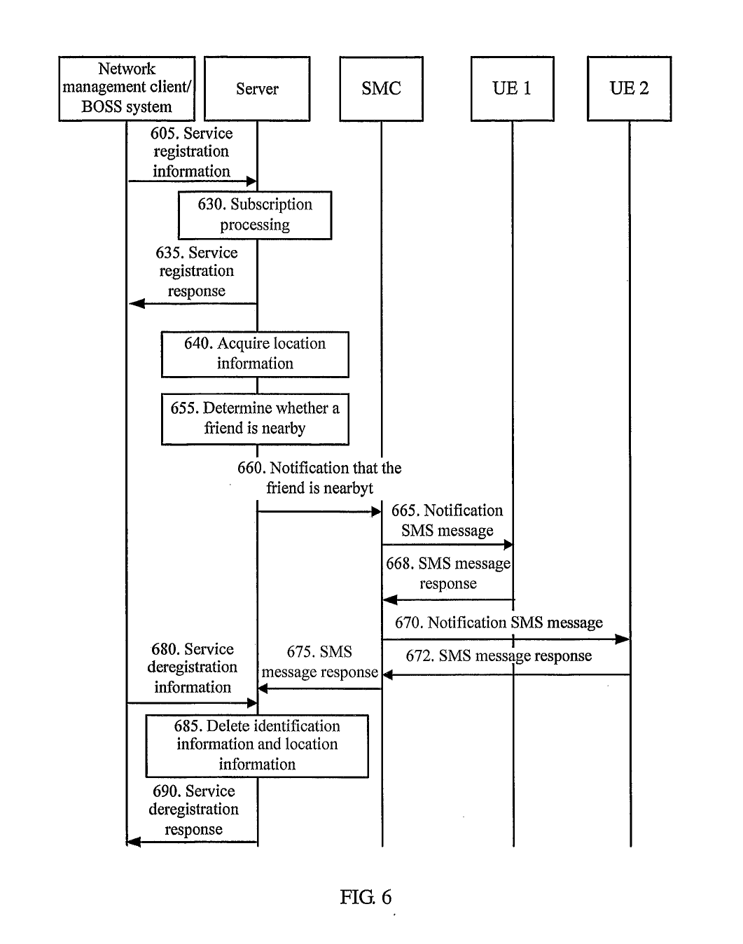

FIG. 6 is a schematic flowchart of a method for determining a user location according to another embodiment of the present invention.

605: A network management client/business operation support system (BOSS, Business operation support system) sends service registration information to a server.

For example, the server may be the server in FIG. 4 or FIG. 5.

For example, after a user A transacts the service by using a mobile terminal or an Internet or going to a counter of an operator, and enables the service after obtaining permission of a friend of the user by using an SMS message or another manner, the network management client/business operation support system may generate service registration information of the user A, and send the service registration information to the server.

For example, a format of the foregoing service registration information may be “command code: enabled; user number: A; number of a friend: B, C, D”, where the command code is used to indicate that the user A has enabled the notification service that a friend is nearby. For example, the service may notify, by using an SMS message, the user A that a user B, C, or D is near the user A when the user B, C, or D is near the user A, so that the user A knows that the user B, C, or D is near the user A. Optionally, the users B, C, and D may also be notified simultaneously, so that the users B, C, and D know that the user A is near the users B, C, and D. Optionally, the service registration information may also contain a user name, so that the user name may be displayed in an SMS message for notification when a friend of the user is notified.

610: After receiving the foregoing service registration information, the server gathers information of the user and the friend of the user that are included in the foregoing service registration information, and performs corresponding service subscription processing.

For example, it is determined that which users allow the user A to enable the service according to the foregoing service registration information, and the service subscription processing is performed. That is, relevant information of a user who allows the user A to enable the service may be set on the server, for example, service subscription information including identities of UEs of the users A, B, and C is set on the server.

Optionally, the service subscription information of the user may be recorded in a form of a list. For example, one field of a line in the list records the identity of the UE of the user A, and other lines record identities of the UEs of the users B, C, and D. The service subscription information of the user is not limited in the embodiment of the present invention, and may also be recorded in a form such as an array.

635: The server replies a service registration response to the network management client/BOSS, so that the network management client/BOSS performs relevant processing such as charging. It should be understood that the step 635 is optional.

640: The server acquires location information. The foregoing location information may use a form of a service bill.

For example, the server may acquire location information of the user from another device (such as, an MSC) that stores (for example, storing in a manner of a service bill) the location information of the user in a manner similar to that of the step 555 in FIG. 5. For another example, location information of a UE may be acquired in a manner similar to that of the step 440 in FIG. 4. Details are not described herein again.

For example, the foregoing service bill may include an identity of the UE, such as, number information of the user (for example, an MSISDN), and location information (such as, an MSC identity, a location area code, and a cell identity) of the UE. For example, user number information and location information may be stored in a form of a list or an array.

655: The server determines whether the friend is nearby according to user number information and location information of a UE in the foregoing service bill and subscription information of the user. The step 655 is similar to the step 555 in FIG. 5 or the step 455 in FIG. 4. Details are not described herein again.

660: When determining that the friend of the user is nearby, the server sends an SMS message sending request to an SMC, where the SMS message sending request is used to request the SMC to send an SMS message to the user, so as to notify the user that the friend is near the user. The step 660 is similar to the step 560 in FIG. 5. Details are not described herein again.

665: After receiving the request from the server, the SMC sends an SMS message for notification to a UE 1.

For example, the SMC may send the SMS message for notification to the user A, so that the user A knows that the user B, C, or D is near the user A.

668: After receiving the SMS message for notification sent by the SMC, the UE 1 sends an SMS message response to the SMC.

For example, the SMS message response is used to notify the SMC that the foregoing SMS message for notification has been received. It should be understood that the step 668 is optional.

670: The SMC sends the SMS message for notification to a UE 2 at the same time.

For example, the SMC may send the SMS message for notification to a UE (such as, the UE 2) of the user B, C, or D while sending the SMS message for notification to the UE 1, so that the user B, C, or D knows that the user A is near the user B, C, or D.

672: After receiving the SMS message for notification sent by the SMC, the UE 2 sends the SMS message response to the SMC.

For example, the SMS message response is used to notify the SMC that the UE 2 has received the foregoing SMS message for notification. It should be understood that the step 672 is optional.

675: After receiving the SMS message response, the SMC forwards the SMS message response to the server.

Optionally, when the user needs to deregister the foregoing service, the steps 680 to 690 may also be performed according to the embodiment of the present invention.

680: The network management client/BOSS sends service deregistration information to the server. The step 680 is similar to the step 580 in FIG. 5. Details are not described herein again.

685: The server deletes corresponding configuration information after receiving the foregoing service deregistration information. The step 685 is similar to the step 585 in FIG. 5. Details are not described herein again.

690: The server replies a service deregistration response to the network management client/BOSS, so that the network management client/BOSS performs relevant processing such as charging. It should be understood that the step 690 is optional.

In the embodiment of the present invention, information interacted between the foregoing devices may use a dedicated signaling message, or may be carried by using an existing message, which is not limited in the present invention.

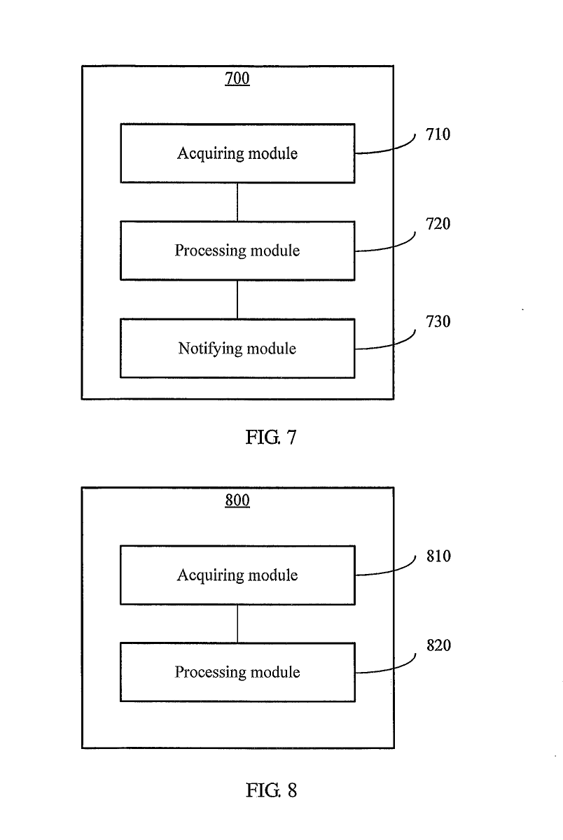

The foregoing describes the method for determining a user location according to the embodiments of the present invention, and the following separately describes, with reference to FIG. 7 and FIG. 8, an apparatus for determining a user location according to an embodiment of the present invention.

FIG. 7 is a schematic structural diagram of an apparatus 700 for determining a user location according to another embodiment of the present invention. The apparatus 700 may be a server 120 according to the embodiment of the present invention, where the apparatus 700 includes: an acquiring module 710, a processing module 720, and a notifying module 730.

The acquiring module 710 acquires first location information of a first UE and second location information of a second UE. The processing module 720 determines whether the first UE is near the second UE according to the first location information and the second location information. The notifying module 730 notifies the first UE or the second UE or both of a message that the first UE is near the second UE when it is determined that the first UE is near the second UE.

According to an embodiment of the present invention, that whether one UE is near another UE can be determined according to location information of UEs, so as to actively notify at least one of the two UEs of a message that the one UE is near the another UE, thereby improving user experience.

Optionally, as another embodiment, the acquiring module 710 is further configured to acquire service registration information of a first UE, where the service registration information includes first identification information of the first UE, second identification information of a second UE, and indication information for registering a service. The acquiring module 710 acquires first location information that corresponds to the first identification information and second location information that corresponds to the second identification information according to the first identification information and the second identification information. The processing module 720 determines whether the first UE is near the second UE according to whether the first location information and the second location information are the same or in a same set.

Optionally, as another embodiment, the notifying module 730 further sends a service enabling request to a second UE through a short message center, so as to request the second UE to allow a first UE to register the service. The processing module 720 determines, when the second UE allows the first UE to register the service, whether the first UE is near the second UE according to whether first location information and second location information are the same or in a same set.

Optionally, as another embodiment, the acquiring module 710 further acquires service registration information of a first UE, where the service registration information includes first identification information, second identification information, and indication information that a service has been enabled. The processing module 720 acquires first location information that corresponds to the first identification information and second location information that corresponds to the second identification information according to the first identification information and the second identification information, and determines whether the first UE is near a second UE according to whether the first location information and the second location information are the same or in a same set.

According to the embodiment of the present invention, the acquiring module 710 further acquires service deregistration information of the first UE, where the service deregistration information includes the first identification information, the second identification information, and indication information for deregistering a service; and deletes the second identification information and the second location information, or deletes the first identification information, the second identification information, the first location information, and the second location information according to the indication information for deregistering a service.

According to the embodiment of the present invention, the acquiring module 710 is further configured to collect a signaling message transmitted on an interface of a core network by using a probe, where the signaling message includes one or more first signaling messages of the first UE and one or more second signaling messages of the second UE, and the one or more first signaling messages includes the first identification information of the first user equipment and the first location information that corresponds to the first identification information, and the one or more second signaling messages includes the second identification information of the second user equipment and the second location information that corresponds to the second identification information; and the acquiring module 710 is configured to acquire the first location information from the one or more first signaling messages, and the second location information from the one or more second signaling messages.

Optionally, as another embodiment, the acquiring module 710 collects a signaling message transmitted on an interface of a core network by using a probe, where the signaling message includes one or more first signaling messages of a first user equipment and one or more second signaling messages of a second user equipment; and is configured to integrate the collected one or more first signaling messages into a first service bill, and integrate the collected one or more second signaling messages into a second service bill, where the first service bill includes first identification information of the first UE and first location information that corresponds to the first identification information, and the second service bill includes second identification information of the second UE and second location information that corresponds to the second identification information. The acquiring module 710 acquires the first location information that corresponds to the first identification information from the first service bill according to the first identification information, and acquires the second location information that corresponds to the second identification information from the second service bill according to the second identification information.

Optionally, as another embodiment, the acquiring module 710 may establish a network connection to a switching device; acquire a first service bill of a first UE and a second service bill of a second UE from the switching device by using the network connection, where the first service bill includes first identification information of the first UE and first location information that corresponds to the first identification information, and the second service bill includes second identification information of the second UE and second location information that corresponds to the second identification information; and acquire the first location information that corresponds to the first identification information according to the first identification information, and acquire the second location information that corresponds to the second identification information according to the second identification information.

According to the embodiment of the present invention, the processing module 720 specifically determines whether the first UE is near the second UE according to the first location information, the second location information, and a location determining policy related to the first location information and the second location information, where the first location information includes at least one of mobile switch center identification information, location area identification information, and cell identification information, and the second location information includes at least one of mobile switch center identification information, location area identification information, and cell identification information.

According to the embodiment of the present invention, the notifying module 730 requests a short message center to notify the first UE or the second UE or both of a message that the first UE is near the second UE in a manner of an SMS message or a multimedia message.

Optionally, as another embodiment, the notifying module 730 may request a switching device to notify the first user equipment or the second user equipment or both of a message that the first user equipment is near the second user equipment in a manner of a voice.

Optionally, as another embodiment, the notifying module 730 may request an instant message server to notify the first user equipment or the second user equipment or both of a message that the first user equipment is near the second user equipment in a manner of an instant chatting message.

Optionally, as another embodiment, the acquiring module 710 further receives and stores first location name information that corresponds to first location information or second location name information that corresponds to second location information; and the notifying module 730 further notifies a second UE of the first location name information, or notifies a first UE of the second location name information, or notifies a first UE of the second location name information and notifies a second UE of the first location name information.

Optionally, as another embodiment, the acquiring module 710 further determines first longitude and latitude information of a first UE according to first location information, or determines second longitude and latitude information of a second UE according to second location information; and the notifying module 730 is further configured to notify the second UE of the first longitude and latitude information, or notify the first UE of the second longitude and latitude information, or notify the first UE of the second longitude and latitude information and notify the second UE of the first longitude and latitude information.

Optionally, as another embodiment, the notifying module 730 further stops notifying a first UE or a second UE or both again of a message that the first UE is near the second UE, after notifying the first UE or the second UE or both of the message that the first UE is near the second UE, and in case that the first UE or the second UE moves within a preset scope.

For operations and functions of each unit in the apparatus 700, refer to the steps 210, 220, and 230 of the method illustrated in FIG. 2. Details are not described herein again for avoiding repetition.

FIG. 8 is a schematic structural diagram of an apparatus 800 for determining a user location according to another embodiment of the present invention. The apparatus 800 may be a server 120 according to the embodiment of the present invention, where the apparatus 800 includes: an acquiring module 810 and a processing module 820.

The acquiring module 810 acquires first location information of a first UE and second location information of a second UE from a signaling message or a switching device. The processing module 820 determines whether the first UE is near the second UE according to the first location information, the second location information, and a location determining policy related to the first location information and the second location information.

According to an embodiment of the present invention, that whether one UE is near another UE can be determined according to location information of UEs, so as to actively notify at least one of the two UEs of a message that the one UE is near the another UE, thereby improving user experience.

According to the embodiment of the present invention, a process of acquiring location information of a UE from a signaling message or a switching device is the same as the process of acquiring location information of a UE in the embodiment of FIG. 7. Details are not described herein again.

According to the embodiment of the present invention, first location information includes at least one of mobile switch center identification information, location area identification information, and cell identification information, and the second location information includes at least one of mobile switch center identification information, location area identification information, and cell identification information. The processing module 820 determines that the first UE is near the second UE when the mobile switch center identification information included in the first location information is the same as the mobile switch center identification information included in the second location information.

Optionally, as another embodiment, the processing module 820 may determine that the first UE is near the second UE if the cell identification information included in the first location information is the same as the cell identification information included in the second location information.

Optionally, as another embodiment, the processing module 820 may determine that the first UE is near the second UE if the location area identification information included in the first location information is the same as the location area identification information included in the second location information.

Optionally, as another embodiment, the processing module 820 may determine that the first UE is near the second UE if a location area code included in the first location information and a location area code included in the second location information are in a same set.

According to the embodiment of the present invention, that whether one UE is near another UE may be determined according to location information that is of the UE and is acquired from the signaling message or the switching device, so as to provide location information to a service related to the location information, thereby improving user experience.

For operations and functions of the units in the apparatus 800, refer to the steps 310 and 320 of the method illustrated in FIG. 3. Details are not described herein again for avoiding repetition.

A communications system is provided according to an embodiment of the present invention, and includes: a first user equipment, a second user equipment, and a server.

The server according the embodiment of the present invention is configured to acquire first location information of a first user equipment and second location information of a second user equipment; determine whether the first user equipment is near the second user equipment according to the first location information and the second location information; and notify the first user equipment or the second user equipment or both of a message that the first user equipment is near the second user equipment when it is determined that the first user equipment is near the second user equipment.

Optionally, as another embodiment, the foregoing communications system further includes: a network management client, configured to send service registration information of a first user equipment to the server, where the service registration information includes first identification information of the first user equipment, second identification information of a second user equipment, and indication information for registering a service; or a business operation support system, configured to send service registration information of a first user equipment to the server, where the service registration information includes first identification information of the first user equipment, second identification information of a second user equipment, and indication information for registering a service. The foregoing server is specifically configured to acquire first location information that corresponds to the first identification information and second location information that corresponds to the second identification information according to the first identification information and the second identification information; determine whether the first user equipment is near the second user equipment according to whether the first location information and the second location information are the same or in a same set; and notify the first user equipment or the second user equipment or both of a message that the first user equipment is near the second user equipment when it is determined that the first user equipment is near the second user equipment.

Optionally, as another embodiment, the foregoing communications system further includes: a short message center, configured to notify, after a request of the server is received, a first user equipment or a second user equipment or both of a message that the first user equipment is near the second user equipment in a manner of an SMS message or a multimedia message.

Optionally, as another embodiment, the foregoing communications system further includes: an external probe, which is disposed on an interface of a core network and is configured to collect one or more first signaling messages of a first user equipment and one or more second signaling messages of a second user equipment that are transmitted on the interface of the core network, where the first user equipment and the second user equipment are service registration related devices and provide the one or more first signaling messages and the one or more second signaling messages to the server, so that the server respectively acquires first location information according to the one or more first signaling messages, and acquires second location information according to the one or more second signaling messages. For example, a service registration related device refers to a user equipment registering a service that the foregoing friend is nearby. After the user equipment registers the foregoing service, the server may record subscription information of the user equipment, where the subscription information includes an identity of the user equipment, and the server may acquire location information that corresponds to the identity according to the identity of the service registration related device.

Optionally, as another embodiment, the foregoing communications system further includes: a switching device, configured to generate a first service bill of a first user equipment and a second service bill of a second user equipment; and establish a network connection to the server, and send the first service bill and the second service bill to the server by using the network connection. The first user equipment and the second user equipment are service registration related devices, the first service bill includes first identification information of the first user equipment and first location information that corresponds to the first identification information, and the second service bill includes second identification information of the second user equipment- and second location information that corresponds to the second identification information, so that the server acquires the first location information that corresponds to the first identification information from the first service bill according to the first identification information, and acquires the second location information that corresponds to the second identification information from the second service bill according to the second identification information.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. Furthermore, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in a form of a software product. The software product is stored in a storage medium, and includes several instructions for instructing a computer device (which may be a personal computer, a server, or a network device) to perform all or a part of the steps of the methods described in the embodiments of the present invention. The storage medium includes any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for determining a user location, the method comprising:
acquiring first location information of a first user equipment and second location information of a second user equipment;
determining whether the first user equipment is near the second user equipment according to the first location information and the second location information; and
notifying the first user equipment or the second user equipment or both of a message that the first user equipment is near the second user equipment when it is determined that the first user equipment is near the second user equipment.

2. The method according to claim 1, further comprising:
acquiring service registration information of the first user equipment, wherein the service registration information comprises first identification information of the first user equipment, second identification information of the second user equipment, and indication information for registering a service; and
wherein acquiring first location information of a first user equipment and second location information of a second user equipment comprises:
acquiring the first location information that corresponds to the first identification information and the second location information that corresponds to the second identification information according to the first identification information and the second identification information.

3. The method according to claim 2, further comprising:
sending a service enabling request to the second user equipment through a short message center, so as to request the second user equipment to allow the first user equipment to register the service; and
wherein determining whether the first user equipment is near the second user equipment according to the first location information and the second location information comprises:
determining whether the first user equipment is near the second user equipment according to the first location information and the second location information when the second user equipment allows the first user equipment to register the service.

4. The method according to claim 1, further comprising:
acquiring service registration information of the first user equipment, wherein the service registration information comprises first identification information of the first user equipment, second identification information of the second user equipment, and indication information that a service has been enabled; and
wherein acquiring first location information of a first user equipment and second location information of a second user equipment comprises:
acquiring the first location information that corresponds to the first identification information and the second location information that corresponds to the second identification information according to the first identification information and the second identification information.

5. The method according to claim 2, further comprising:
acquiring service deregistration information of the first user equipment, wherein the service deregistration information comprises the first identification information, the second identification information, and the indication information for deregistering a service; and
deleting the second identification information and the second location information according to the indication information for deregistering a service, or deleting the first identification information, the second identification information, the first location information, and the second location information according to the indication information for deregistering a service.

6. The method according to claim 1, further comprising:
collecting a signaling message transmitted on an interface of a core network by using a probe, wherein the signaling message comprises one or more first signaling messages of the first user equipment and one or more second signaling messages of the second user equipment, the one or more first signaling messages comprises the first identification information of the first user equipment and the first location information that corresponds to the first identification information, and the one or more second signaling messages comprises the second identification information of the second user equipment and the second location information that corresponds to the second identification information; and
wherein acquiring first location information of a first user equipment and second location information of a second user equipment comprises:
acquiring the first location information from the one or more first signaling messages according to the first identification information, and acquiring the second location information from the one or more second signaling messages according to the second identification information.

7. The method according to claim 1, further comprising:
collecting a signaling message transmitted on an interface of a core network by using a probe, wherein the signaling message comprises one or more first signaling messages of the first user equipment and one or more second signaling messages of the second user equipment;
integrating the collected one or more first signaling messages into a first service bill, and integrating the collected one or more second signaling messages into a second service bill, wherein the first service bill comprises the first identification information of the first user equipment and the first location information that corresponds to the first identification information, and the second service bill comprises the second identification information of the second user equipment and the second location information that corresponds to the second identification information; and
wherein acquiring first location information of a first user equipment and second location information of a second user equipment comprises:
acquiring the first location information that corresponds to the first identification information from the first service bill according to the first identification information, and acquiring the second location information that corresponds to the second identification information from the second service bill according to the second identification information.

8. The method according to claim 1, further comprising:
establishing a network connection to a switching device;
acquiring a first service bill of the first user equipment and a second service bill of the second user equipment from the switching device by using the network connection, wherein the first service bill comprises the first identification information of the first user equipment and the first location information that corresponds to the first identification information, and the second service bill comprises the second identification information of the second user equipment and the second location information that corresponds to the second identification information; and
wherein acquiring first location information of a first user equipment and second location information of a second user equipment comprises:
acquiring the first location information that corresponds to the first identification information from the first service bill according to the first identification information, and acquiring the second location information that corresponds to the second identification information from the second service bill according to the second identification information.

9. The method according to claim 1, wherein determining whether the first user equipment is near the second user equipment according to the first location information and the second location information comprises:
determining whether the first user equipment is near the second user equipment according to the first location information, the second location information, and a location determining policy related to the first location information and the second location information, wherein the first location information comprises at least one of identification information of a mobile switch center, location area identification information, and cell identification information, and the second location information comprises at least one of identification information of the mobile switch center, location area identification information, and cell identification information.

10. The method according to claim 9, wherein determining whether the first user equipment is near the second user equipment according to the first location information, the second location information, and a location determining policy related to the first location information and the second location information comprises:
if the identification information of the mobile switch center comprised in the first location information is the same as the identification information of the mobile switch center comprised in the second location information, determining that the first user equipment is near the second user equipment; or
if the cell identification information comprised in the first location information is the same as the cell identification information comprised in the second location information, determining that the first user equipment is near the second user equipment; or
if the location area identification information comprised in the first location information is the same as the location area identification information comprised in the second location information, determining that the first user equipment is near the second user equipment; or
if a location area code comprised in the first location information and a location area code comprised in the second location information are in a same set, determining that the first user equipment is near the second user equipment.

11. The method according to claim 1, wherein notifying the first user equipment or the second user equipment or both of a message that the first user equipment is near the second user equipment comprises:
requesting a short message center to notify the first user equipment or the second user equipment or both of the message that the first user equipment is near the second user equipment in a manner of an SMS message or a multimedia message; or
requesting the switching device to notify the first user equipment or the second user equipment or both of the message that the first user equipment is near the second user equipment in a manner of a voice; or
requesting an instant message server to notify the first user equipment or the second user equipment or both of the message that the first user equipment is near the second user equipment in a manner of an instant chatting message.

12. The method according to claim 1, further comprising:
receiving and storing first location name information that corresponds to the first location information or second location name information that corresponds to the second location information; and
wherein notifying the first user equipment or the second user equipment or both of a message that the first user equipment is near the second user equipment comprises:
notifying the second user equipment of the first location name information; or
notifying the first user equipment of the second location name information; or
notifying the first user equipment of the second location name information and notifying the second user equipment of the first location name information.

13. The method according to claim 1, further comprising:
determining first longitude and latitude information of the first user equipment according to the first location information, or determining second longitude and latitude information of the second user equipment according to the second location information; and
wherein notifying the first user equipment or the second user equipment or both of a message that the first user equipment is near the second user equipment comprises:
notifying the second user equipment of the first longitude and latitude information; or
notifying the first user equipment of the second longitude and latitude information; or
notifying the first user equipment of the second longitude and latitude information and notifying the second user equipment of the first longitude and latitude information.

14. The method according to claim 1, further comprising:
stopping notifying the first user equipment or the second user equipment or both again of the message that the first user equipment is near the second user equipment after the first user equipment or the second user equipment or both is notified of the message that the first user equipment is near the second user equipment, and in a case that the first user equipment or the second user equipment moves within a preset scope.

15. A method for determining a user location, the method comprising:
acquiring first location information of a first user equipment and second location information of a second user equipment from a signaling message or a switching device; and
determining whether the first user equipment is near the second user equipment according to the first location information, the second location information, and a location determining policy related to the first location information and the second location information.

16. The method according to claim 15, wherein:
the first location information comprises at least one of identification information of a mobile switch center, location area identification information, and cell identification information;
the second location information comprises at least one of identification information of the mobile switch center, location area identification information, and cell identification information; and
wherein determining whether the first user equipment is near the second user equipment according to the first location information, the second location information, and a location determining policy related to the first location information and the second location information comprises:
if the identification information of the mobile switch center comprised in the first location information is the same as the identification information of the mobile switch center comprised in the second location information, determining that the first user equipment is near the second user equipment; or
if the cell identification information comprised in the first location information is the same as the cell identification information comprised in the second location information, determining that the first user equipment is near the second user equipment; or
if the location area identification information comprised in the first location information is the same as the location area identification information comprised in the second location information, determining that the first user equipment is near the second user equipment; or
if a location area code comprised in the first location information and a location area code comprised in the second location information are in a same set, determining that the first user equipment is near the second user equipment.

17. An apparatus for determining a user location, the apparatus comprising:
an acquiring module, configured to acquire first location information of a first user equipment and second location information of a second user equipment;
a processing module, configured to determine whether the first user equipment is near the second user equipment according to the first location information and the second location information; and
a notifying module, configured to notify the first user equipment or the second user equipment or both of a message that the first user equipment is near the second user equipment when it is determined that the first user equipment is near the second user equipment.

18. The apparatus according to claim 17, wherein the acquiring module is configured to:
acquire service registration information of the first user equipment, wherein the service registration information comprises first identification information of the first user equipment, second identification information of the second user equipment, and indication information for registering a service; and
acquire the first location information that corresponds to the first identification information and the second location information that corresponds to the second identification information according to the first identification information and the second identification information.

19. The apparatus according to claim 18, wherein:
the notifying module is configured to send an SMS message for requesting service enabling to the second user equipment through a short message center, so as to request the second user equipment to allow the first user equipment to register the service; and
the processing module is configured to determine whether the first user equipment is near the second user equipment according to the first location information and the second location information when the second user equipment allows the first user equipment to register the service.

20. The apparatus according to claim 17, wherein the acquiring module is configured to:
acquire service registration information of the first user equipment, wherein the service registration information comprises the first identification information, the second identification information, and indication information that a service has been enabled; and
acquire the first location information that corresponds to the first identification information and the second location information that corresponds to the second identification information according to the first identification information and the second identification information.

21. The apparatus according to claim 18 wherein:
the acquiring module is further configured to acquire service deregistration information of the first user equipment, and the service deregistration information comprises the first identification information, the second identification information and the indication information for deregistering a service; and
the processing module is further configured to delete the second identification information and the second location information according to the indication information for deregistering a service, or delete the first identification information, the second identification information, the first location information and the second location information according to the indication information for deregistering a service.

22. The apparatus according to claim 17, wherein the acquiring module is configured to:
collect a signaling message transmitted on an interface of a core network by using a probe, wherein the signaling message comprises one or more first signaling messages of the first user equipment and one or more second signaling messages of the second user equipment, the one or more first signaling messages comprises the first identification information of the first user equipment and the first location information that corresponds to the first identification information, and the one or more second signaling messages comprises the second identification information of the second user equipment and the second location information that corresponds to the second identification information; and
acquire the first location information from the one or more first signaling messages according to the first identification information, and acquire the second location information from the one or more second signaling messages according to the second identification information.

23. The apparatus according to claim 17, wherein the acquiring module is configured to:
collect a signaling message transmitted on an interface of a core network by using a probe, wherein the signaling message comprises one or more first signaling messages of the first user equipment and one or more second signaling messages of the second user equipment; integrate the collected one or more first signaling messages into a first service bill, and integrate the collected one or more second signaling messages into a second service bill, wherein the first service bill comprises the first identification information of the first user equipment and the first location information that corresponds to the first identification information, and the second service bill comprises the second identification information of the second user equipment and the second location information that corresponds to the second identification information; and
acquire the first location information that corresponds to the first identification information from the first service bill according to the first identification information, and acquire the second location information that corresponds to the second identification information from the second service bill according to the second identification information.

24. The apparatus according to claim 17, wherein the acquiring module is configured to:
establish a network connection to a switching device; and acquire a first service bill of the first user equipment and a second service bill of the second user equipment from the switching device by using the network connection, wherein the first service bill comprises the first identification information of the first user equipment and the first location information that corresponds to the first identification information, and the second service bill comprises the second identification information of the second user equipment and the second location information that corresponds to the second identification information; and
acquire the first location information that corresponds to the first identification information from the first service bill according to the first identification information, and acquire the second location information that corresponds to the second identification information from the second service bill according to the second identification information.

25. The apparatus according to claim 17, wherein the processing module is configured to determine whether the first user equipment is near the second user equipment according to the first location information, the second location information, and a location determining policy related to the first location information and the second location information; wherein the first location information comprises at least one of identification information of a mobile switch center, location area identification information, and cell identification information, and the second location information comprises at least one of identification information of the mobile switch center, location area identification information, and cell identification information.

26. The apparatus according to claim 17, wherein the notifying module is configured to:
request a short message center to notify the first user equipment or the second user equipment or both of a message that the first user equipment is near the second user equipment in a manner of an SMS message or a multimedia message; or
request the switching device to notify the first user equipment or the second user equipment or both of a message that the first user equipment is near the second user equipment in a manner of a voice; or
request an instant message server to notify the first user equipment or the second user equipment or both of a message that the first user equipment is near the second user equipment in a manner of an instant chatting message.

27. The apparatus according to claim 17, wherein:
the acquiring module is further configured to receive and store first location name information that corresponds to the first location information or second location name information that corresponds to the second location information; and
the notifying module is further configured to notify the second user equipment of the first location name information, or notify the first user equipment of the second location name information, or notify the first user equipment of the second location name information and notify the second user equipment of the first location name information.

28. The apparatus according to claim 17, wherein:
the acquiring module is further configured to determine first longitude and latitude information of the first user equipment according to the first location information, or determine second longitude and latitude information of the second user equipment according to the second location information; and
the notifying module is further configured to notify the second user equipment of the first longitude and latitude information, or notify the first user equipment of the second longitude and latitude information, or notify the first user equipment of the second longitude and latitude information and notify the second user equipment of the first longitude and latitude information.

29. The apparatus according to claim 17, wherein the notifying module is further configured to stop notifying the first user equipment or the second user equipment or both again of the message that the first user equipment is near the second user equipment after notifying the first user equipment or the second user equipment or both of the message that the first user equipment is near the second user equipment, and in a case that the first user equipment or the second user equipment moves within a preset scope.

30. An apparatus for determining a user location, the apparatus comprising:
an acquiring module, configured to acquire first location information of a first user equipment and second location information of a second user equipment from a signaling message or a switching device; and
a processing module, configured to determine whether the first user equipment is near the second user equipment according to the first location information, the second location information, and a location determining policy related to the first location information and the second location information.

31. The apparatus according to claim 30, wherein:
the first location information comprises at least one of identification information of a mobile switch center, location area identification information, and cell identification information, and the second location information comprises at least one of identification information of the mobile switch center, location area identification information, and cell identification information; and
the processing module is configured to:
if the identification information of the mobile switch center comprised in the first location information is the same as the identification information of the mobile switch center comprised in the second location information, determine that the first user equipment is near the second user equipment; or
if the cell identification information comprised in the first location information is the same as the cell identification information comprised in the second location information, determine that the first user equipment is near the second user equipment; or if the location area identification information comprised in the first location information is the same as the location area identification information comprised in the second location information, determine that the first user equipment is near the second user equipment; or
if a location area code comprised in the first location information and a location area code comprised in the second location information are in a same set, determine that the first user equipment is near the second user equipment.

32. A communications system, comprising:
a first user equipment and a second user equipment; and
a server, configured to:
acquire first location information of the first user equipment and second location information of the second user equipment; determine whether the first user equipment is near the second user equipment according to the first location information and the second location information, and
notify the first user equipment or the second user equipment or both of a message that the first user equipment is near the second user equipment when it is determined that the first user equipment is near the second user equipment.

33. The system according to claim 32, further comprising:
a network management client, configured to send service registration information of the first user equipment to the server, wherein the service registration information comprises first identification information of the first user equipment, second identification information of the second user equipment, and indication information for registering a service; or
a business and operation support system, configured to send service registration information of the first user equipment to the server, wherein the service registration information comprises first identification information of the first user equipment, second identification information of the second user equipment, and indication information for registering a service; and
wherein the server is configured to:
acquire the first location information that corresponds to the first identification information and the second location information that corresponds to the second identification information according to the first identification information and the second identification information;
determine whether the first user equipment is near the second user equipment according to whether the first location information and the second location information are the same or in a same set; and
notify the first user equipment or the second user equipment or both of the message that the first user equipment is near the second user equipment when it is determined that the first user equipment is near the second user equipment.

34. The system according to claim 32, further comprising:
a short message center, configured to notify the first user equipment or the second user equipment or both of the message that the first user equipment is near the second user equipment in a manner of an SMS message or a multimedia message after a request of the server is received.

35. The system according to claim 32, further comprising:
an external probe, disposed on an interface of a core network and configured to collect one or more first signaling messages of the first user equipment and one or more second signaling messages of the second user equipment that are transmitted on the interface of the core network, wherein the first user equipment and the second user equipment are service registration related devices and provide the one or more first signaling messages and the one or more second signaling messages to the server, so that the server respectively acquires the first location information according to the one or more first signaling messages, and acquires the second location information according to the one or more second signaling messages.

36. The system according to claim 32, further comprising:
a switching device, configured to generate a first service bill of the first user equipment and a second service bill of the second user equipment; and establish a network connection to the server, and send the first service bill and the second service bill to the server by using the network connection, wherein the first user equipment and the second user equipment are service registration related devices, the first service bill comprises first identification information of the first user equipment and the first location information that corresponds to the first identification information, and the second service bill comprises second identification information of the second user equipment and the second location information that corresponds to the second identification information, so that the server acquires the first location information that corresponds to the first identification information from the first service bill according to the first identification information, and acquires the second location information that corresponds to the second identification information from the second service bill according to the second identification information.
